(19) United States
(12) Patent Application Publication
(10) Pub. No.: US 2004/0049870 A1
(43) Pub. Date: Mar. 18, 2004

(54) Substrate scrubbing apparatus having stationary brush member in contact with edge bevel of rotating substrate

(75) Inventors: Robert Tolles, San Jose, CA (US); David P. Alvarez, San Jose, CA (US); Jeffrey G. Knirck, Sunnyvale, CA (US); Leon Volfovski, Mountain View, CA (US)

Correspondence Address: PATENT COUNSEL, APPLIED MATERIALS, INC., Legal Affairs Department, P.O.BOX 450A, Santa Clara, CA, 95052, US

(73) Assignee: APPLIED MATERIALS, INC.

(21) Appl. No.: 10/601,826

(22) Filed: Jun. 23, 2003

Related U.S. Application Data
(60) Provisional application No. 60/390,765, filed on Jun. 21, 2002.

(51) Int. Cl. B08B 1/00

(52) U.S. Cl. 15/77; 15/88.1

(57) ABSTRACT

An apparatus is provided for scrubbing a substrate's edge. The apparatus comprises a stationary surface (i.e., a surface that does not rotate in a direction in which the substrate rotates) that is positioned so as to contact an edge (e.g., a circumferential edge, an edge portion of the substrate's major surface or a beveled surface of the substrate's edge) such that as the substrate rotates, a dragging force is generated between the stationary surface and the rotating substrate. In a preferred aspect the apparatus is adapted to support a substrate in a generally vertical orientation, and the stationary surface is positioned along a lower portion of the substrate's edge, such that fluid applied to the major surface of the substrate will flow onto, and thereby rinse, the stationary surface. Such a preferred configuration also may allow a substrate to be loaded and unloaded without needing to move the stationary surface. Preferably, when a substrate is loaded into the scrubbing apparatus, the substrate's edge will contact the stationary surface, and a separate step for positioning the stationary surface will not be needed.

The present application claims priority from U.S. Provisional Patent Application Serial No. 60/390,765, filed Jun. 21, 2002, which is hereby incorporated by reference herein in its entirety.

### FIELD OF THE INVENTION

This invention is concerned with semiconductor manufacturing, and is more particularly concerned with apparatus for scrubbing substrates.

### BACKGROUND OF THE INVENTION

Fabrication of semiconductor devices entails performing a sequence of processes with regard to a substrate such as a silicon wafer. One process that may be required is cleaning the substrate to remove particles therefrom. If the particles were not removed, the devices to be formed on the substrate might be damaged by the particles.

A known type of device for removing particles from a substrate is referred to as a “scrubber”. A conventional scrubber is schematically illustrated in side view in FIG. 1.

In FIG. 1, reference numeral 11 generally indicates a conventional scrubber. Reference numeral 13 indicates a substrate that is being processed (scrubbed) by the scrubber 11. The scrubber 11 includes a plurality of rollers 15 that are arranged to support the substrate 13 in a vertical orientation, while rotating the substrate, as indicated by the arrow 17. The vertically oriented substrate 13 is positioned between two cylindrical brushes (of which only one brush 19 is shown in FIG. 1) which each contact a respective side of the substrate 13. Each brush 19 is rotated about its longitudinal axis, as indicated by the arrow 21. A cleaning fluid may be introduced to the surfaces of the substrate 13 via the brushes 19, or via a spray nozzle (not shown).

One area in which it is desirable to improve the performance of conventional scrubbers is in the removal of particles from the edge bevel of the substrate.

### SUMMARY OF THE INVENTION

An apparatus is provided for scrubbing a substrate's edge. The apparatus comprises a stationary surface (i.e., a surface that does not rotate in a direction in which the substrate rotates) that is positioned so as to contact an edge (e.g., a circumferential edge, an edge portion of the substrate's major surface or a beveled surface of the substrate's edge) such that as the substrate rotates, a dragging force is generated between the stationary surface and the rotating substrate. In a preferred aspect the apparatus is adapted to support a substrate in a generally vertical orientation, and the stationary surface is positioned along a lower portion of the substrate's edge, such that fluid applied to the major surface of the substrate will flow onto, and thereby rinse, the stationary surface. Such a preferred configuration also may allow a substrate to be loaded and unloaded without needing to move the stationary surface. Preferably, when a substrate is loaded into the scrubbing apparatus, the substrate's edge will contact the stationary surface, and a separate step for positioning the stationary surface will not be needed.

### BRIEF DESCRIPTION OF THE DRAWINGS

FIG. 1 is a schematic side view of a conventional substrate scrubber;

FIG. 2 is a schematic side view of a scrubber provided according to a first aspect of the invention;

FIG. 3 is an isometric view of one embodiment of the inventive scrubber of FIG. 2;

FIG. 4 is a schematic partial side view of a scrubber provided in accordance with another aspect of the invention;

FIG. 5 is a schematic partial top plan view of the inventive scrubber of FIG. 4;

FIG. 6 is a cross-sectional view of a substrate, showing the beveled edges of the substrate in juxtaposition with a stationary brush member that is part of the inventive scrubber of FIGS. 4 and 5;

FIG. 7 is a side view of an embodiment of the stationary brush member of FIG. 6; and

FIG. 8 is a side schematic view of an embodiment of the invention comprising a stationary roller.

### DETAILED DESCRIPTION

In accordance with the invention, the rotary brushes of the conventional scrubber are supplemented by an additional stationary brush member which contacts one or both of the edge bevels of the substrate and applies a brushing action to the edge bevel or edge bevels of the substrate resulting from the rotation of the substrate against the stationary brush member. In this way, removal of particles from the edge bevel is improved.

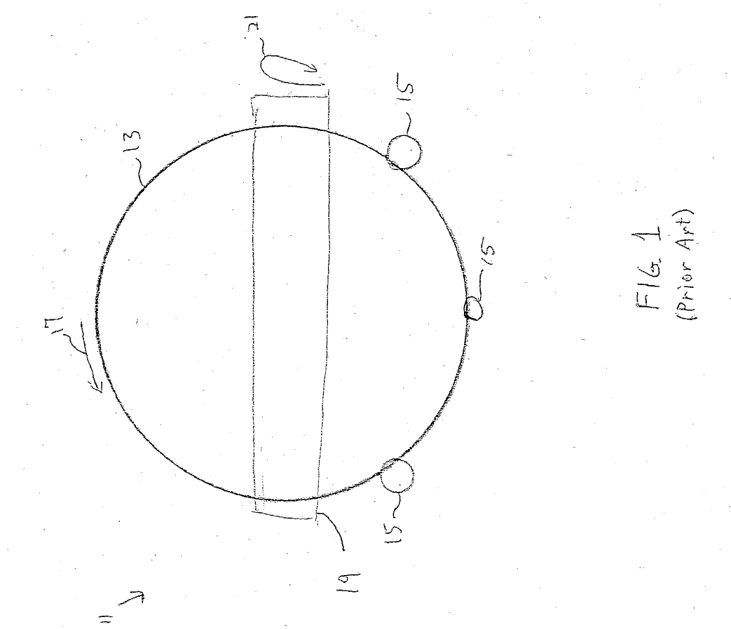

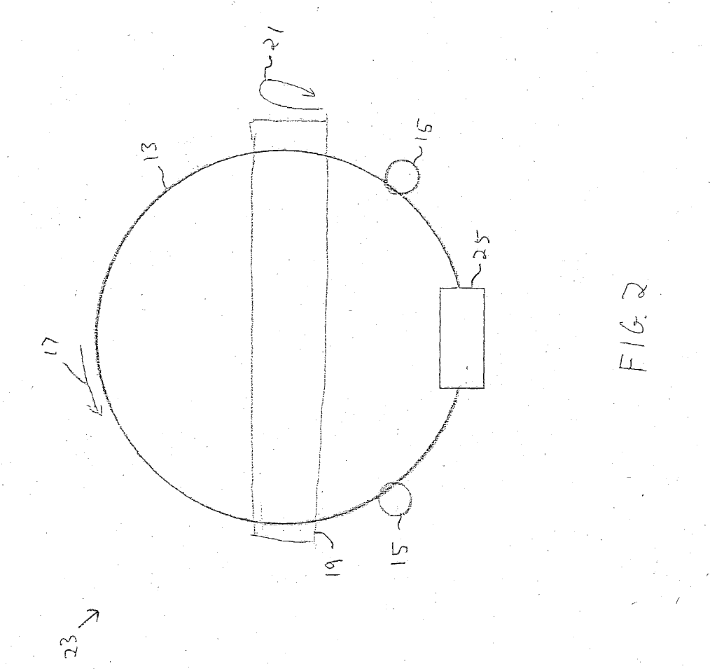

FIG. 2 is a schematic side view, similar to FIG. 1, of a scrubber 23 which is provided in accordance with an aspect of the invention. The inventive scrubber 23 of FIG. 2 may include all of the components of a conventional scrubber, such as those referred to in connection with the conventional scrubber 11 described in connection with FIG. 1. In addition, the inventive scrubber 23 includes a stationary brush arrangement 25 which may include one or more brush members positioned between two of the rollers 15 (e.g., adjacent the bottom of the vertically oriented substrate 13) and in contact with one or both of the front and back side edge bevels (not separately shown) of the substrate 13. The rotation of the substrate 13 results in a scrubbing or dragging action applied to the edge bevel or edge bevels of the substrate 13 by the stationary brush arrangement 25 which is in contact with the edge bevel or bevels.

It will be understood that when the stationary brush arrangement 25 is employed instead of employing a third substrate support roller 15 (as shown in FIG. 1), the stationary brush arrangement 25 will contact both the front and back side of the edge bevel so as to aid in support of the substrate 13. The stationary brush arrangement 25 may be adapted to extend along an arc that corresponds to a portion of the substrate 13's circumference. In this manner, a larger portion of the substrate's circumference is scrubbed than that achieved with conventional edge brushes or abrasive support rollers. Further, because the stationary brush arrangement 25 is stationary and does not rotate with the substrate as the substrate rotates, greater dragging force is thereby applied to the substrate. Additionally, when the stationary brush arrangement 25 is positioned below the brushes 19, fluid applied to the substrate 13 (e.g., via spray nozzles (not shown) or through the brushes 19) may flow onto the stationary brush arrangement 25 during substrate cleaning, and thereby rinse particles therefrom. Thus, in a preferred aspect, the conventional need for a dedicated fluid source for cleaning the edge brush mechanism is eliminated. In one aspect, as shown in FIG. 8, the edge cleaning arrangement 25 may comprise a stationary roller 61 (i.e., a roller that remains stationary and does not roll or rotate with the substrate 13) having an easily deformable material 63 (such as PVA) positioned along a bottom and/or along the lower edges of the roller groove 65.

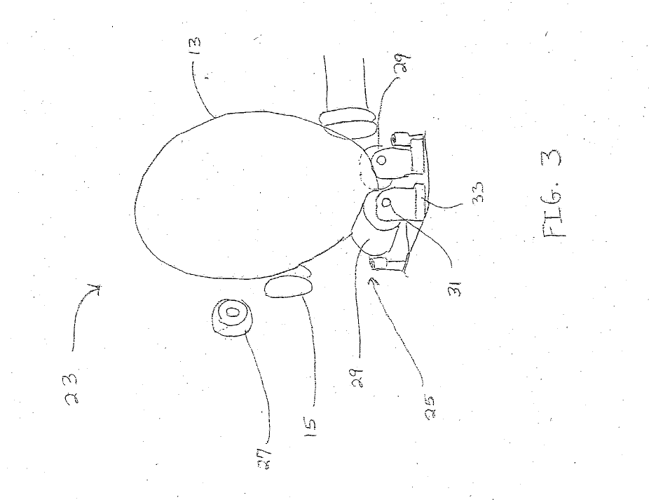

FIG. 3 is a partial isometric view of an embodiment of the inventive scrubber 23 of FIG. 2. The conventional rotary brushes 19, of which one is shown in FIG. 2, are omitted to simplify FIG. 3. However, rotary brush mounts 27 for the rotary brushes are shown. The stationary brush arrangement 25 is constituted, in the embodiment of FIG. 3, by a pair of cylindrical brush members 29. The brush members 29 may be formed of an easily deformable material such as polyvinyl alcohol (PVA). In one embodiment, each brush member 29 is one-and-a-half inches long and has a diameter of one inch.

It will be observed that the brush members are mounted at the bottom of the vertically oriented substrate 13, between the rollers 15 which support the substrate 13. The brush members 29 are mounted in proximity to each other, such that, when the substrate 13 is supported on the rollers 15, each of the brush members 29 is in contact with a respective edge bevel of the substrate 13.

Each brush member 29 may be mounted on a respective pin 31 coinciding with a longitudinal axis of the respective brush member 29. Each pin 31 may be mounted in a horizontal orientation, parallel to the plane of the substrate 13, by a pair of mounting blocks 33. The mounting arrangement for the brush members 29 may be such that the distance between the pins 31 can be adjusted to adjust a degree of compression imparted to the brush members 29 by the substrate 13 when the substrate 13 is present.

Although the brush members 29 are stationary during processing (scrubbing) of the substrate 13 by the inventive scrubber 23, the brush members 29 may be mounted so as to allow rotation thereof (e.g., by hand, when no substrate is present) so that a fresh portion of the brush members 29 may be presented for contact with the substrate 13.

As an alternative to maintaining the brush members 29 stationary during scrubbing of the substrate 13, it is also contemplated to rotate the brush members 29 about pin 21 during scrubbing of the substrate.

In operation, the substrate 13 is positioned so as to be supported in a vertical orientation on the rollers 15. The positioning of the substrate 13 on the rollers 15 brings an edge bevel (or both edge bevels as in the embodiment shown in FIG. 3) of the substrate 13 into contact with the stationary brush arrangement 25. The rotary brushes represented by the brush 19 in FIG. 2 are brought into contact with respective surfaces of the substrate 13. The substrate 13 is rotated (as indicated by the arrow 17) by, e.g., a motor (not shown) coupled to one or more of the rollers 15. At the same time, the rotary brushes 19 (FIG. 2) are caused to rotate as indicated by the arrow 21. Scrubbing of the major surfaces of the substrate 13 is performed by action of the rotary brushes 19. At the same time, a scrubbing action is applied to the edge bevel or edge bevels of the substrate 13 by virtue of the motion of the substrate 13 relative to the stationary brush arrangement 25 which is in contact with the edge bevel or edge bevels of the substrate 13. Cleaning fluid applied to the substrate 13 via the rotary brushes may flow down the substrate 13 to the stationary brush arrangement 25 (e.g., to the brush members 29), and may thereby enhance the scrubbing effect of the stationary brush arrangement 25 upon the edge bevels of the substrate 13. Because of the interaction of the stationary brush arrangement 25 with the edge bevel or edge bevels of the substrate 13, superior cleaning of the edge bevel or edge bevels may be achieved.

Although not shown in the drawings, a mechanism may be provided to direct a jet of fluid to the brush members 29 to rinse particles out of the brush members 29.

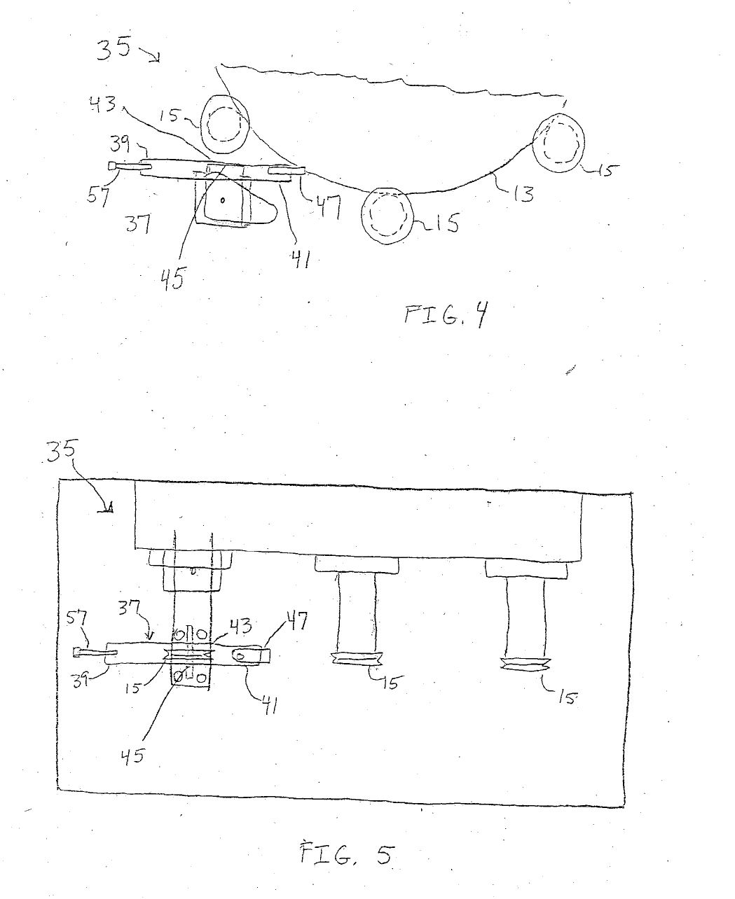

A scrubber provided in accordance with a second aspect of the invention will now be described with reference to FIGS. 4-6. FIG. 4 is a partial side schematic view of a scrubber 35 provided in accordance with the second aspect of the invention. FIG. 5 is a partial schematic top plan view of the inventive scrubber 35 according to the second aspect of the invention. The inventive scrubber 35 may have all of the components of a conventional scrubber, including those of the conventional scrubber 11 described in conjunction with FIG. 1. However, to simplify the drawings, the rotary brushes represented by the brush 19 in FIG. 1 are not shown in FIGS. 4 and 5.

The inventive scrubber 35 includes a finger 37 which may be mounted adjacent to the bottom of the substrate 13. The finger 37 has a first end 39 that extends away from the substrate 13 and a second end 41 which extends toward the substrate 13. The finger 37 also has a central portion 43 at which the finger 37 is pivotally mounted by means of a pivot 45. The finger 37 may balance on the pivot 45 in such a manner that the second end 41 of the finger 37 tilts upwardly when the substrate 13 is not present. In addition, or alternatively, a spring or other biasing mechanism (not shown) may be provided to bias the finger 37 such that the second end 41 of the spring 37 tilts upwardly when the substrate 13 is not present.

A brush member 47 is mounted on the second end of the finger 37 and is adapted to contact the edge bevels of the substrate 13 when the substrate 13 is supported on the rollers 15. The brush member 47 may, for example, be formed of PVA, or any other easily deformable and suitably low particle material. As shown in FIG. 4, when the inventive scrubber 35 is in operation, the finger 37 may be in a substantially horizontal position.

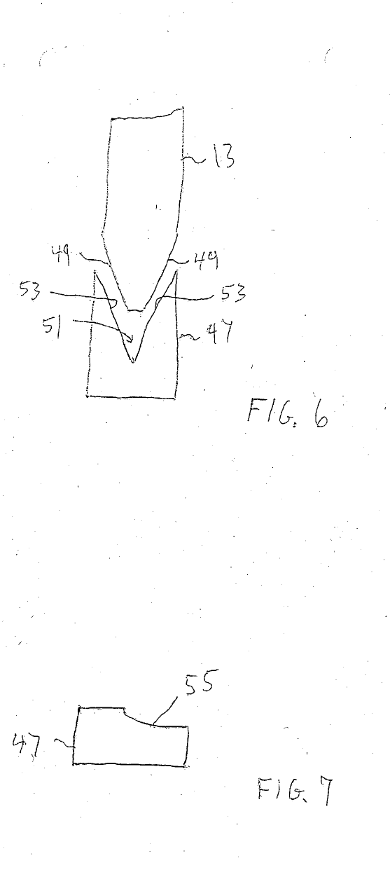

FIG. 6 is a partial cross-sectional view of the substrate 13, showing the substrate 13 in juxtaposition with the brush member 47. Edge bevels 49 of the substrate 13 are shown in FIG. 6.

As shown in FIG. 6, the brush member 47 may have a slotted profile, such as that provided by the V-shaped slot 51 illustrated in FIG. 6. The V-shaped slot 51 includes opposed sides 53, each of which is adapted to contact a respective one of the edge bevels 49 of the substrate 13, and is comprised of an easily deformable material such as PVA or any conventional polishing pad material. It will be appreciated that, in practice, the substrate 13 is lowered from the position shown in FIG. 6 so that the edge bevels 49 of the substrate 13 are brought into contact with the opposed sides 53 of the brush member 47. As the substrate 13 is rotated, the brush member 47 applies a scrubbing action to the edge bevels 49 of the substrate 13 to remove particles from the edge bevels 49.

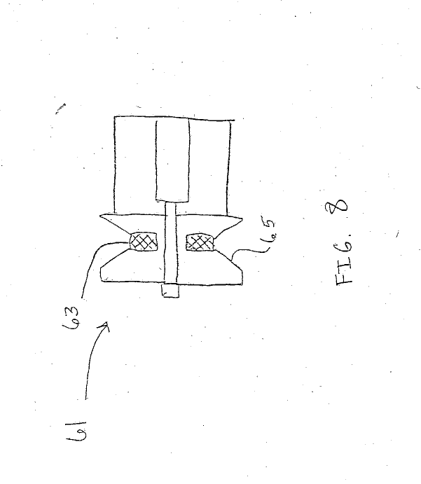

FIG. 7 is a side view of an embodiment of the brush member 47. To increase an area of contact between the brush member 47 and the substrate 13 in the circumferential direction of the substrate 13 (thereby improving scrubbing of the substrate 13 by the brush member 47), the brush member 47 may be provided with a curved profile, as indicated at 55 in FIG. 7, in the direction of the circumference of the substrate 13, to substantially conform to the curvature of the substrate 13 in the circumferential direction of the substrate 13. The curved profile 55 of the brush member 47 may correspond, for example, to substantially 5° of the arc of the substrate 13. Like the embodiment of FIG. 6, the curved profile of the brush member is comprised of a deformable material such as PVA or any conventional polishing pad material.

Except for the substitution of the brush member 47 for the brush arrangement 25 of the scrubber 23 of FIGS. 2 and 3, the inventive scrubber 35 of the second aspect of the invention functions in substantially the same manner as the scrubber 23 of FIGS. 2 and 3. Accordingly, operation of the scrubber 35 need not be further described. Like the embodiments of FIGS. 2 and 3, fluid that cleans the substrate 13 may flow therefrom onto the brush member 47 to thereby clean the brush member 47.

Instead of being arranged to contact both edge bevels of the substrate 13, the brush member 47 may be arranged to contact only one of the edge bevels. A respective finger with brush member mounted thereon may be provided for each of the edge bevels of the substrate 13.

An amount of force by which the brush member 47 is urged against the edge bevels of the substrate 13 may be adjusted by adjusting a position of a weight (e.g., a screw 57, FIGS. 4 and 5) that may be carried by the first end 39 of the finger 37, or by otherwise applying a downward force on the first end 39 of the finger 37.

It will be apparent that any of the embodiments described above may be positioned at any location along the edge bevel of the substrate, and may be used to clean a substrate in any orientation (e.g., vertical or horizontally oriented substrates, etc.). It will be apparent that the embodiment of FIGS. 4 and 5 could be easily modified for scrubbing substrates that are positioned in other orientations. For example, when scrubbing a horizontally oriented substrate, the finger mechanism of FIGS. 4 and 5 could be modified so as to pivot about a vertical axis (rather than about a horizontal axis, as shown), to thereby press against the edge bevel of the substrate.

As used herein a stationary surface refers to a surface that, during cleaning, does not move on the direction the substrate rotates. Such a stationary surface may therefore be moved into and out of contact with the substrate and/or may rotate about an axis perpendicular to the substrate's axis of rotation.

Accordingly, while the present invention has been disclosed in connection with exemplary embodiments thereof, it should be understood that other embodiments may fall within the spirit and scope of the invention, as defined by the following claims.

The invention claimed is:

1. An apparatus adapted to scrub a substrate, comprising:
a plurality of rollers adapted to rotationally support a substrate in a substantially vertical orientation; and
at least one brush member positioned to contact an edge bevel of the substrate with a stationary surface of the brush member at a location between two of the rollers.

2. An apparatus adapted to scrub a substrate, comprising:
a plurality of rollers adapted to rotationally support a substrate in a substantially vertical orientation;
a finger having a first end extending away from the substrate, a second end extending toward the substrate, and a central portion between the first end and the second end, the finger being pivotally mounted at the central portion; and
a brush member mounted on the second end of the finger and in contact with an edge bevel of the substrate.
